(19) United States
(12) Patent Application Publication
(10) Pub. No.: US 2009/0291361 A1
(43) Pub. Date: Nov. 26, 2009

(54) Wearable power supply for soldiers

(76) Inventor: Dino Scorziello, Delmont, PA (US)

Correspondence Address: Dino Scorziello, 176 South Street, #3, Plainville, MA, 02762, US

(21) Appl. No.: 12/152,913

(22) Filed: May 20, 2008

(51) Int. Cl. H01M 2/24

(52) U.S. Cl. 429/150; 429/160

(57) ABSTRACT

A four-cell stick (40) is made from four 3.6 V lithium-thionyl chloride cells (10) connected in series. Five, four-cell sticks (40) are connected in parallel to form a 14V power pack (60). Two 14 V power packs (60) are connected in series (35) and in parallel (30) to create a 1920 W-hr power source (80). The 1920 W-hr power source (80) contains a 14V power outlet (50) and a 28 V power outlet (70). The 1920 W-hr power source (80) is contained in a fabric enclosure (90). Its mass is less than 4 kg making it suitable to be worn by people. The 1920 W-hr power source (80) can be equipped with backup cells (100) to create an extended-life 1920 W-hr power source, and still remain below 4 kg in mass. A one-switch extended-life 1920 W-hr power source (130) contains a three-way switch (150) to direct power from the backup cells (100) to either the 14 V power outlet (50) or the 28 V power outlet (70). The 2-switch extended-life 1920 W-hr power source (160) contains one backup switch to the 14 V power outlet (110) and one backup switch to the 28 V power outlet (120). The backup switches allow users to draw upon the backup cells (100) when needed and direct power to the desired outlet. A one-switch wearable extended-life 1920 W-hr power source (135) is a one-switch extended-life 1920 W-hr power source (130) in a fabric enclosure (90) for ease of conveyance. A two-switch wearable extended-life 1920 W-hr power source (165) is a two-switch extended-life 1920 W-hr power source (160) in a fabric enclosure (90) for ease of conveyance.

### CROSS-REFERENCE TO RELATED APPLICATIONS

Not applicable.

### BACKGROUND—FIELD OF INVENTION

This invention relates to battery packs specifically to battery packs that weigh less than 4 kg and can produce 1920 W-hr in a 96 hour period.

### BACKGROUND—DESCRIPTION OF PRIOR ART

Various types of DC dry cell batteries constitute the state-of-the-art power supply for dismounted warfighters. However, the amount of batteries needed to complete a 96 hour mission is estimated to weigh approximately 9 kg. Current battery packs are heavy and do not provide sufficient power. It would be advantageous to have a battery pack that could provide at least 1920 W-hr within a 96 hour period and weigh less than 4 kg. Soldiers using this battery pack would be at an advantage because their electrical equipment would continue to operate and they would not become fatigued as quickly when wearing it.

### SUMMARY

In accordance with the present invention, high energy lithium batteries are connected in a preselected electrical configuration to generate about 1920 W-hr within a 96 hour period and weighs 4 kg or less when assembled. The batteries are enclosed in a fabric container for ease of conveyance.

### OBJECTS AND ADVANTAGES

Accordingly, several objects and advantages of my invention are:
a) to provide users with a long lasting, high power battery pack.
b) to provide users with a low weight, long lasting, high power battery pack.
c) to provide users with allow weight, long lasting, high power battery pack that can be assembled with readily available off-the-shelf equipment.

It will also allow users to become less tired while wearing my battery pack because it weighs less than currently available battery packs. Still further objects and advantages will become apparent from a consideration of the ensuing description and drawing.

### DRAWING FIGURES

FIG. 1 shows a high energy lithium battery with wires extending from each end.

FIG. 2 shows 4 high energy lithium batteries connected in series to form a battery stick.

FIG. 3 shows 5 high energy lithium battery sticks connected together in parallel to form a battery pack.

FIG. 4 shows 2 high energy lithium battery packs connected together in series and in parallel to form a light weight power source.

FIG. 5 shows a light weight power source contained within a fabric enclosure.

FIG. 6 shows a one-switch light weight power source with backup high energy batteries to form an extended-life light weight power source. A three-way switch is used to direct backup electricity to the desired power outlet.

FIG. 7 shows the one-switch extended-life light weight power source contained in a fabric enclosure.

FIG. 8 shows a two-switch extended-life light weight power source. This extended-life light weight power source uses two separate switches to control the backup electricity to each power outlet.

FIG. 9 shows the two-switch extended life light weight power source contained in a fabric enclosure.

Reference Numerals In Drawings

| | |
|---|---|
| 10 - 3.6 V lithium-thionyl chloride cell | 90 - fabric enclosure |
| 20 - wire/lead | 95 - wearable 1920 W-hr power source |
| 30 - parallel | 100 - backup cells |
| 35 - series | 110 - backup switch to the 14 V power outlet |
| 40 - four-cell stick | 120 - backup switch to the 28 V power outlet |
| 50 - 14 V power outlet | 130 - 1-switch extended-life 1920 W-hr power source |
| 60 - 14 V power pack | 150 - three-way switch (on-off-on) |
| 70 - 28 V power outlet | 160 - 2-switch extended-life 1920 W-hr power source |

80 - 1920 W-hr power source
135 - 1-switch wearable extended-life 1920 W-hr power source
165 - 2-switch wearable extended-life 1920 W-hr power source

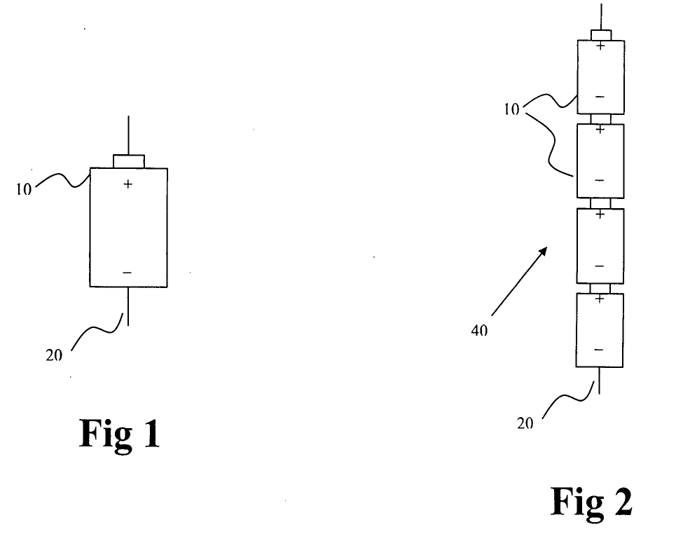

### DESCRIPTION—FIGS. 1-5—PREFERRED EMBODIMENT

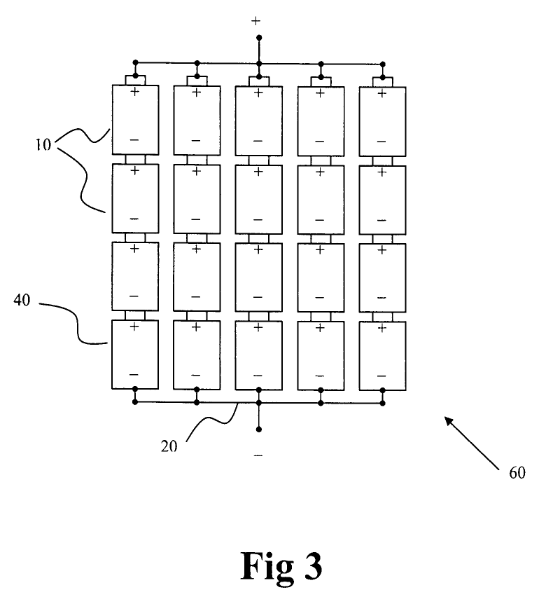

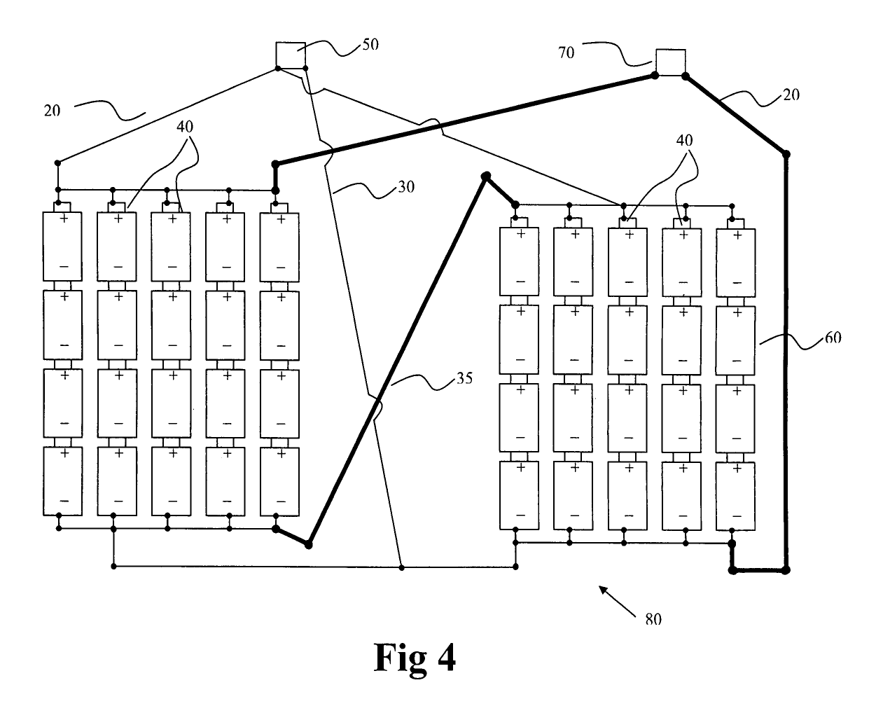

FIG. 1 shows a high energy lithium battery such as but not limited to a 3.6 V lithium-thionyl chloride cell 10. Each one weighs about 90 grams. It has leads or wires 20 connected to it. FIG. 2 shows a four-cell stick 40 comprising of but not limited to, four 3.6 V lithium-thionyl chloride cells 10. The cells are in series making its voltage around 14.4 V. The cells can be soldered together at the leads or held together with heat shrinkable tubing. FIG. 3 shows five, four-cell sticks 40 connected together in parallel to form a 14 V power pack 60.

FIG. 4 shows two 14 V power packs 60, connected together in parallel 30 and in series 35 forming a 1920 W-hr power source 80. The preselected electrical configuration generates about 1920 W-hr of electricity. The wires or leads 20 can be soldered together or twisted together or held together with heat shrinkable tubing. A standard 14 V power outlet 50 is provided along with a standard 28 V power outlet 70. Suitable power outlets can be selected by those skilled in the art to suit the needs of the user.

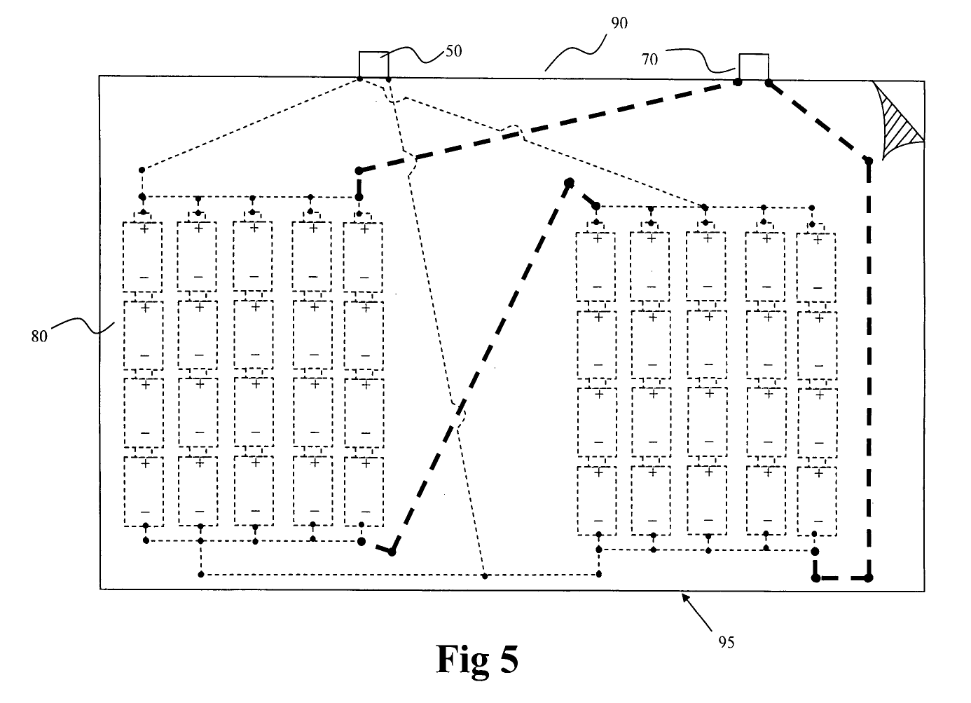

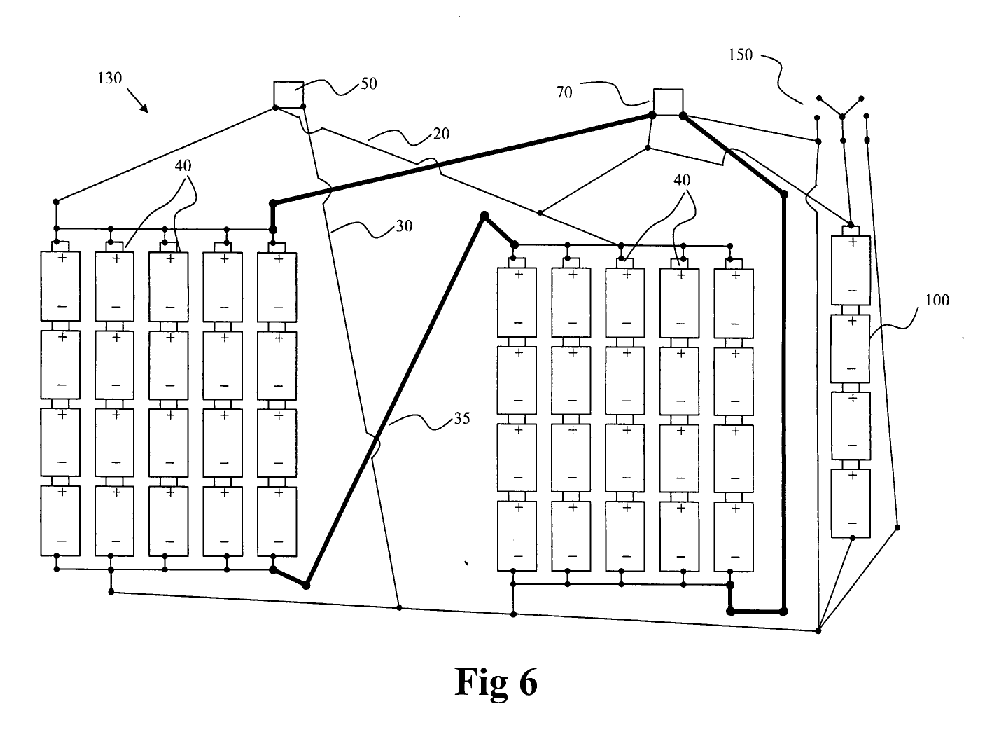

FIG. 5 shows a wearable 1920 W-hr power source 95 comprising of a 1920 W-hr power source 80 contained in a fabric enclosure 90. The fabric enclosure 90 can be made of but not limited to GOR-TEX® fabric, woven carbon fibers, woven aramid fibers, woven high performance polypropylene fibers, woven nylon fibers, or woven cotton fibers. The fabric enclosure 90 can be camouflaged to match the soldier's uniform and surrounding terrain.

### FIGS. 6, 7, 8, 9—Additional Embodiments

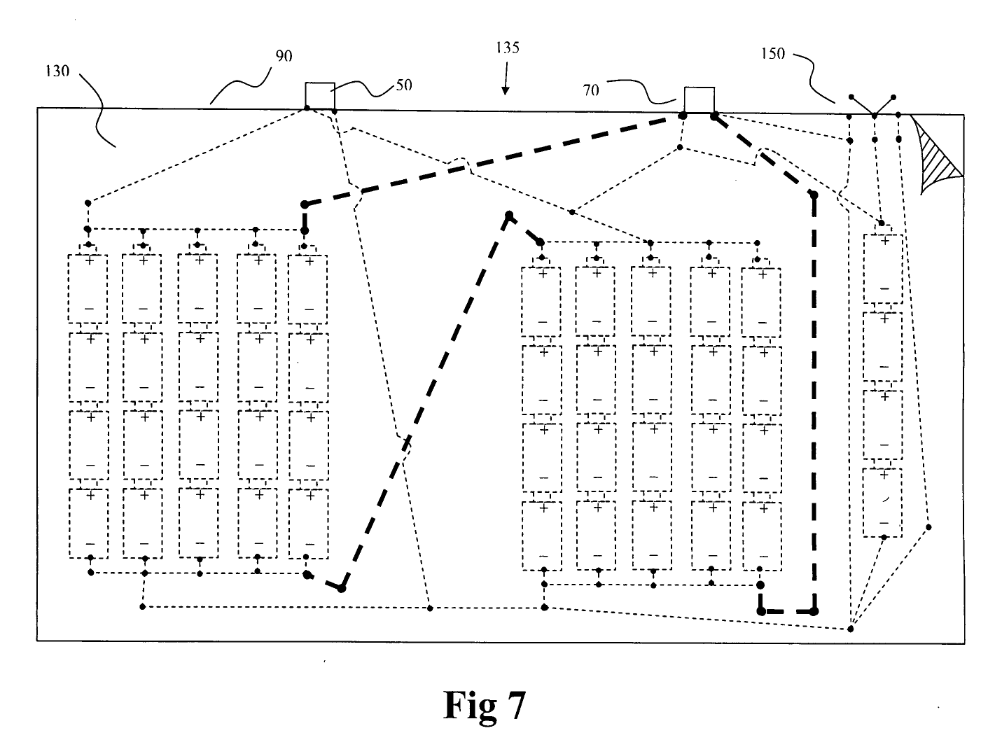

FIG. 6 shows a 1-switch extended-life 1920 W-hr power source 130 with backup cells 100. The backup cells 100 consist of but are not limited to 3.6 V lithium-thionyl chloride cells 10. There may be a single backup cell or a plurality of backup cells. Four are shown to limit the weight of the power source. The backup cells 100 are connected in series to each other. The preselected electrical configuration allows the backup cells to supplement the 1920 W-hr power source. The backup cells can be connected together by soldering their leads together or by using heat shrinkable tubing. A three-way switch 150 (on-off-on) is provided. It can be a rocker switch or a slider switch. A suitable switch can be selected by someone skilled in the art. FIG. 7 shows a wearable 1-switch extended-life 1920 W-hr power source 135 with backup cells 100 contained in a fabric enclosure 90. The fabric enclosure can be made of but not limited to GOR-TEX® fabric, woven carbon fibers, woven aramid fibers, woven high performance polypropylene fibers, woven nylon fibers or woven cotton fibers. The three-way switch 150 is kept outside the fabric enclosure. The wearable power sources may contain multiple 14 V outlets (not shown) and/or multiple 28 V outlets (not shown) for connecting several pieces of equipment.

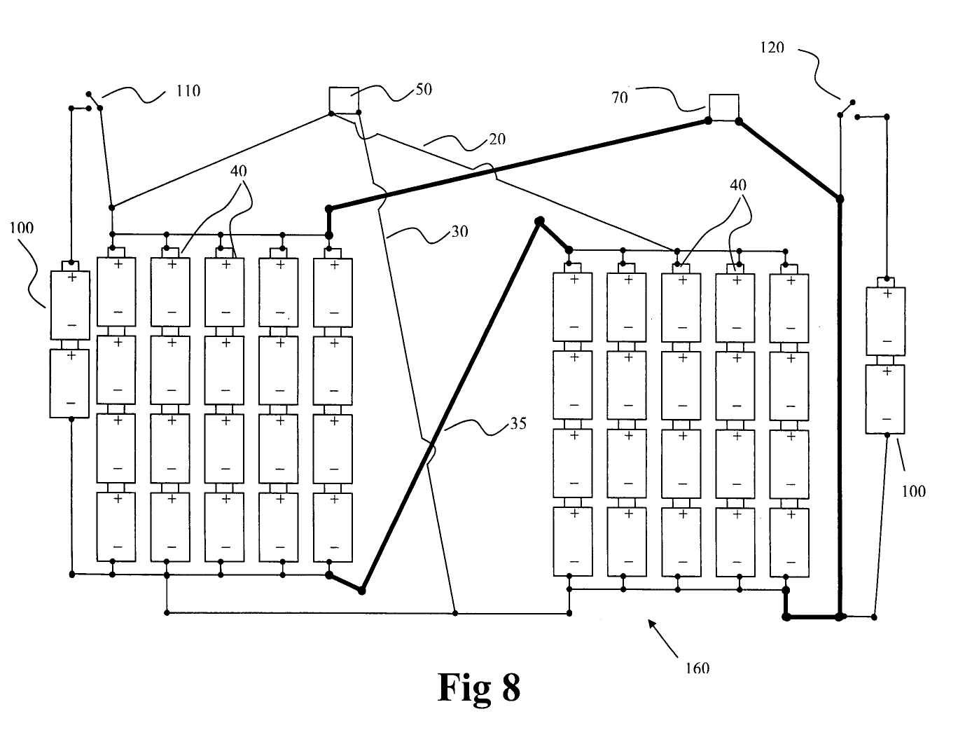

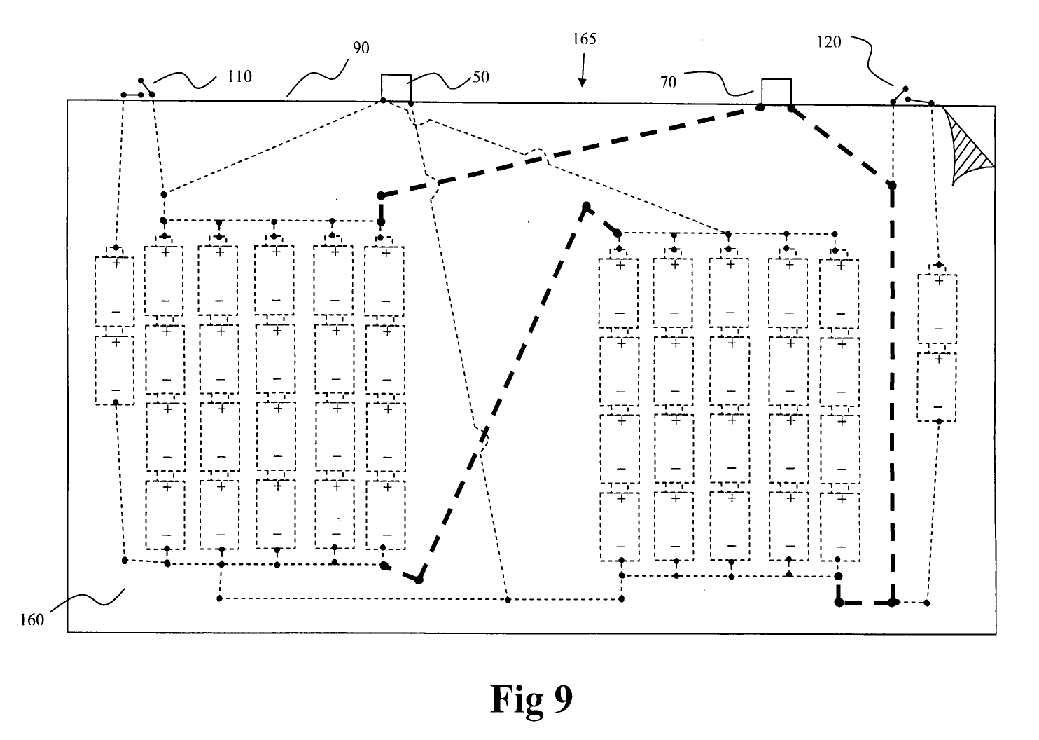

FIG. 8 shows a 2-switch extended-life 1920 W-hr power source 160 with backup cells 100. The backup cells 100 consist of but are not limited to 3.6 V lithium-thionyl chloride cells 10. There may be 1 backup cell or a plurality of backup cells 100 per individual 14 V power pack 60. FIGS. 8 and 9 show 2 backup cells 100 per individual 14 V power pack 60, to limit the weight of the power source. The backup cells are connected in series to each individual 14 V power pack 60. The backup cells can be connected together by soldering their leads together or by using heat shrinkable tubing. A backup switch to the 14 V power outlet 110 is provided. A backup switch to the 28 V power outlet 120 is also provided. The switches can be rocker switches or slider switches. Suitable switches can be selected by someone skilled in the art. FIG. 9 shows a wearable 2-switch extended-life 1920 W-hr power source 165 with backup cells 100 contained in a fabric enclosure 90. The fabric enclosure can be made of but not limited to GOR-TEX® fabric, woven carbon fibers, woven aramid fibers, woven high performance polypropylene fibers, woven nylon fibers or woven cotton fibers. The 14 V backup switch 110 and 28 V backup switch 120 are kept outside the fabric enclosure. The wearable power sources may contain multiple 14 V outlets (not shown) and/or multiple 28 V sockets (not shown) for connecting several pieces of equipment.

### Advantages

From the description above, several advantages of my wearable power supply for soldiers becomes evident:
(a) Soldiers can be equipped with 1920 W-hr of power in a power pack that weighs less than 4 kg.
(b) Soldiers can be equipped with 1920 W-hr of power along with backup cells to provide more power when needed, in a power pack that weighs less than 4 kg.
(c) Soldiers can be equipped with 1920 W-hr of power in a power pack that weighs less than 4 kg, made from standard readily available components.
(d) If a portion of my 1920 W-hr power pack is damaged in the field, the circuitry allows the power pack to keep functioning and remain useful.
(e) Using water resistant GOR-TEX® fabric or other woven fabric as an enclosure allows the power pack to remain dry and not short out, while allowing the batteries the ability to vent off gases if required.

### Operation—FIG. 5, 6, 7, 8, 9

The manner of using the light weight power pack is simple for easy operation in the field. FIG. 5 shows a fully operational 1920 W-hr power source 80. Power is available when equipment is connected to an outlet. A person can connect equipment requiring 14 V to the 14 V power outlet 50. Equipment requiring 28 V can be connected to the 28 V power outlet 70. Since the 14 V power packs 60 are connected in series 35 and in parallel 30 the wearable power source 95 can sustain damage and still be able to provide electricity to some equipment. Since the batteries are contained within a fabric enclosure 90, the power pack can be conveyed by a person in any manner suiting his needs.

FIG. 6 shows a 1-switch 1920 W-hr power source with backup cells 130. FIG. 7 shows a fully operational 1-switch wearable extended-life 1920 W-hr power source 135 with backup cells 100. Since the batteries are contained within a fabric enclosure 90, the power pack can be carried by a person in any manner suiting his needs. A person can connect equipment requiring 14 V into the 14 V power outlet 50. Equipment requiring 28 V can be connected to the 28 V power outlet 70. If the power source has been used for extensive periods of time and more power is required from it, a person can utilize power from the backup cells 100 by closing the three-way switch 150. If extra power is needed for equipment connected to the 14 V power outlet 50 a person can close the three-way switch 150 to direct power from the backup cells 100 to the 14 V power outlet 50. If extra power is needed for equipment connected to the 28 V power outlet 70 a person can close the three-way switch 150 to direct power from the backup cells 100 to the 28 V power outlet 70. The 1-switch extended-life 1920 W-hr power source provides backup power to one outlet at a time, but it provides more power to the selected outlet than the 2-switch extended-life 1920 W-hr power source described herein.

FIG. 8 shows a 2-switch extended-life 1920 W-hr power source 160 with backup cells 100 and separate backup switches. One backup switch is for the 14 V power outlet 110. One backup switch is for the 28 V power outlet 120. FIG. 9 shows a fully operational 2-switch wearable extended-life 1920 W-hr power source 165 with backup cells and 2 separate backup power switches. Since the batteries are contained within a fabric enclosure 90, the power pack can be conveyed by a person in manner suiting his needs. A person can connect equipment requiring 14 V into the 14 V power outlet 50. Equipment requiring 28 V can be connected to the 28 V power outlet 70. If the power pack has been used for extensive periods of time and more power is required from it, a person can draw power from the backup batteries by closing the switches. If extra power is needed for equipment connected to the 14 V power outlet 50 a person can close the backup switch to the 14 V power outlet 110. If extra power is needed for equipment connected to the 28 V power outlet 70 a person can close the backup switch to the 28 V power outlet 120. The 2-switch extended-life 1920 W-hr power source can provide backup power to both the 14 V power socket and the 28 V power socket at the same time, if desired.

### CONCLUSION, RAMIFICATIONS AND SCOPE

Accordingly, the reader will see that my wearable power pack for soldiers is a helpful accessory that will provide sufficient power during a mission. It weighs less than 4 kg thus helping to reduce soldier fatigue. It is weather resistant so it will not short out. Furthermore, it can be made from readily available standard off-the-shelf equipment allowing for quick production in large quantities.

While my above description contains many specificities, these should not be construed as limitations on the scope of the invention, but rather as an exemplification of one preferred embodiment thereof. Accordingly, the scope of the invention should be determined not by the embodiment illustrated but by the appended claims and their legal equivalents.

I claim:

1. A power source for generating electricity, comprising:
about 40 high energy 3.6V lithium-thionyl chloride batteries connected in a preselected electrical configuration to generate about 1920 W-hr of electricity.

2. The power source of claim 1, wherein said high energy 3.6V lithium-thionyl chloride batteries are enclosed in a fabric container for ease of conveyance.

3. A 1920 W-hr power source comprising:
two 14 V power packs connected in series to provide about 28 V and in parallel to provide about 14 V;
said 14 V power packs further comprising of about five 14 V power sticks connected in parallel;
said 14 V power sticks further comprising of about four high energy 3.6V lithium-thionyl chloride batteries.

4. The power source of claim 3, wherein said high energy 3.6V lithium-thionyl chloride batteries are enclosed in a fabric container for ease of conveyance.

5. The power source of claim 3 further comprising:
a plurality of high energy 3.6V lithium-thionyl chloride batteries connected in a preselected configuration to provide backup electricity.

6. The power source of claim 5, wherein said high energy 3.6V lithium-thionyl chloride batteries are enclosed in a fabric container for ease of conveyance.

7. The power source of claim 4 further comprising:
an outlet for supplying about 14 V of electricity;
an outlet for supplying about 28 V of electricity.

8. The power source of claim 7 further comprising:
a three-way power switch connected to said 14 V outlet and said 28 V outlet;
a plurality of high energy 3.6V lithium-thionyl chloride batteries connected to said three-way switch, said 14 V outlet, and said 28 V outlet, to provide backup electricity.

9. The power source of claim 8, wherein said high energy 3.6V lithium-thionyl chloride batteries are enclosed in a fabric container for ease of conveyance.

10. The power source of claim 7 further comprising:
one backup power switch connected to said 14 V outlet;
one backup power switch connected to said 28 V outlet;
one backup high energy 3.6V lithium-thionyl chloride battery connected to said 14 V switch to provide backup electricity;
one backup high energy 3.6V lithium-thionyl chloride battery connected to said 28 V switch to provide backup electricity.

11. The power source of claim 10 further comprising:
one backup high energy 3.6V lithium-thionyl chloride batteries connected to said 14 V switch to provide backup electricity.

12. The power source of claim 10 further comprising:
one backup high energy 3.6V lithium-thionyl chloride batteries connected to said 28 V switch to provide backup electricity.

13. The power source of claim 11 further comprising:
one backup high energy 3.6V lithium-thionyl chloride batteries connected to said 28 V switch to provide backup electricity.
